(19) United States
(12) Patent Application Publication
(10) Pub. No.: US 2025/0218705 A1
(43) Pub. Date: Jul. 3, 2025

(54) SWITCH DEVICE

(71) Applicant: OMRON Corporation, Kyoto-shi (JP)

(72) Inventors: Keisuke KIHARA, Kyoto-shi (JP); Hiroto YONEHARA, Kyoto-shi (JP); Hiroshi OKAMOTO, Kyoto-shi (JP)

(21) Appl. No.: 18/967,682

(22) Filed: Dec. 4, 2024

(30) Foreign Application Priority Data
Dec. 28, 2023 (JP) 2023-223063

(51) Int. Cl. H01H 13/06; H01H 9/02; H01H 9/22; H01H 13/14; H01H 13/50

(52) U.S. Cl. CPC H01H 13/06; H01H 9/0264; H01H 9/22; H01H 13/14; H01H 13/50

(57) ABSTRACT

A switch device includes a switch body, a lead wire, a sealing member, and a holder. The switch body includes a switch housing and a first terminal protruding from the switch housing. The lead wire includes a tip portion fixed to the first terminal. The sealing member seals the first terminal and the tip portion. The holder covers the sealing member. The holder includes a connection portion disposed within the holder. The holder is fixed to the switch body by attaching the connection portion to the first terminal.

### CROSS-REFERENCE TO RELATED APPLICATION

This application claims priority to Japanese Patent Application No. 2023-223063, filed Dec. 28, 2023. The contents of that application are incorporated by reference herein in their entirety.

### FIELD

The claimed invention relates to a switch device.

### BACKGROUND

Some switch devices include a switch body and a holder. The switch body includes a switch housing and a terminal. The terminal protrudes from the switch housing. A lead wire is connected to the terminal. The holder covers the connection portion between the terminal and the lead wire. Furthermore, in order to protect the connection portion, the inside of the holder is filled with a sealing member such as resin. For example, in the switch device disclosed in International Publication WO2020/179289, a holder is placed over a switch body and houses a sealing member.

In the above-referenced switch device, the holder is placed over the switch body in order to fix the holder to the switch body. Therefore, the holder has an outer shape larger than the switch body, and the holder is large in size. An object of the claimed invention is to reduce the size of a holder that covers a sealing member in a switch device.

### SUMMARY

An embodiment of a switch device in accordance with the claimed invention includes a switch body, a lead wire, a sealing member, and a holder. The switch body includes a switch housing and a first terminal protruding from the switch housing. The lead wire includes a tip portion fixed to the first terminal. The sealing member seals the first terminal and the tip portion. The holder covers the sealing member. The holder includes a connection portion disposed within the holder. The holder is fixed to the switch body by attaching the connection portion to the first terminal.

In the switch device, the connection portion is disposed within the holder, and the holder is fixed to the switch body by attaching the connection portion to the first terminal. The holder is thereby made smaller.

The connection portion may be attached to the first terminal by a snap-fit. In this case, the connection portion can be attached to the first terminal with a simple structure. The holder is thereby made smaller.

The first terminal may include a notch. The connection portion may be engaged with the notch, so that the holder is prevented from coming off in a direction in which the first terminal protrudes from the switch housing. In this case, the holder is prevented from coming off by the engagement between the connection portion and the notch.

The connection portion may include a first snap-fit portion and a second snap-fit portion. The first snap-fit portion may extend from an inner surface of the holder, be disposed on a first lateral side relative to the first terminal and engage with the first terminal. The second snap-fit portion may extend from the inner surface of the holder, be disposed on a second lateral side opposite the first lateral side with respect to the first terminal, and engage with the first terminal. In this case, the first snap-fit portion and the second snap-fit portion engage with the first terminal from both lateral sides of the first terminal. The connection portion is thereby firmly attached to the first terminal.

The holder may include a snap-fit retainer that prevents the first snap-fit portion and the second snap-fit portion from spreading apart. The snap-fit retainer may include a first extending portion and a second extending portion. The first extending portion may extend from the inner surface of the holder and be disposed on the first lateral side of the first snap-fit portion. The second extending portion may extend from the inner surface of the holder and be disposed on the second lateral side of the second snap-fit portion. In this case, the snap-fit retainer prevents the first snap-fit portion and the second snap-fit portion from spreading apart. The connection portion is thereby firmly attached to the first terminal.

The switch body may include a second terminal protruding from the switch housing. The holder may include a terminal presser extending from the inner surface of the holder. The terminal presser contacts the second terminal from a direction opposite to a direction in which the connection portion is engaged with the first terminal by snap-fitting. In this case, the terminal presser contacts the second terminal, thereby preventing the holder from moving in a direction in which the snap-fit of the connection portion comes off from the first terminal. The connection portion is thereby firmly attached to the first terminal.

The terminal presser may extend obliquely from the inner surface of the holder toward the second terminal. In this case, when the terminal presser is bent, the elastic force of the terminal presser presses the terminal presser against the second terminal. The connection portion is thereby firmly attached to the first terminal.

The switch body may include a second terminal protruding from the switch housing. The connection portion may include a first snap-fit portion and a second snap-fit portion. The first snap-fit portion may extend from the inner surface of the holder and engage with the first terminal. The second snap-fit portion may extend from the inner surface of the holder and engage with the second terminal. In this case, the degree of freedom in arranging the first snap-fit portion and the second snap-fit portion is improved.

The holder may include a first holder member and a second holder member. The first holder member may include a mounting projection. The second holder member may include a mounting hole and may be a separate body from the first holder member. The first holder member may be attached to the second holder member by press-fitting the mounting projection into the mounting hole. In this case, the first holder member is attached to the second holder member while preventing the holder from becoming large.

The connection portion may be attached to the first terminal by press-fitting. In this case, the connection portion is attached to the first terminal with a simple structure. The holder is thereby made smaller.

The connection portion may include a first press-fit portion and a second press-fit portion. The first press fit portion may include a first recess and extend from the inner surface of the holder. The second press-fit portion may include a second recess and extend from the inner surface of the holder. The first terminal may be press-fit between the first recess and the second recess. In this case, the connection portion is attached to the first terminal with a simple structure. The holder is thereby made smaller.

The switch housing may include a bottom portion and a groove. The bottom portion may be disposed in the holder. The groove may be provided on a side surface of the bottom portion. The holder may include a protrusion that protrudes toward the inside of the holder. The protrusion may be engaged with the groove, thereby preventing the holder from coming off in a direction in which the first terminal protrudes from the switch housing. In this case, the holder is prevented from coming off by the engagement between the protrusion and the groove while preventing the holder from becoming large.

The holder may include a lead protector. The lead protector may include a lead hole and protrude from a side surface of the holder. The lead wire may extend through the lead hole. In this case, the lead wire is protected by the lead protector.

The outer shape of the holder may be same as or smaller than the outer shape of the switch housing. The outer shape of the holder may be disposed flush with the outer shape of the switch housing. In this case, the holder is made smaller.

### BRIEF DESCRIPTION OF THE DRAWINGS

FIG. 1 is a perspective view showing an embodiment of a switch device in accordance with the claimed invention.

FIG. 2 is an exploded perspective view showing the switch device.

FIG. 3 is a perspective view showing a holder and a switch body.

FIG. 4 is a bottom view showing the holder and the switch body.

FIG. 5 is a perspective view showing the holder.

FIG. 6 is a perspective view showing a first holder member.

FIG. 7 is a perspective view showing a second holder member.

FIG. 8 is a cross-sectional view taken along line VIII-VIII in FIG. 4.

FIG. 9 is a perspective view showing a switch device of a first modified embodiment.

FIG. 10 is an enlarged perspective view showing a switch device of the first modified embodiment.

FIG. 11 is a bottom view showing a holder and a switch body of the switch device of a second modified embodiment.

FIG. 12 is a bottom view showing a holder and a switch body of a switch device of a third modified embodiment.

FIG. 13 is a bottom view showing a holder and a switch body of a switch device of a fourth modified embodiment.

FIG. 14 is a perspective view of a first holder member of the switch device of the fourth modified embodiment.

FIG. 15 is a bottom view showing a holder and a switch body of a switch device of a fifth modified embodiment.

FIG. 16 is a rear view showing a first holder member and a switch body of a switch device of a sixth modified embodiment.

FIG. 17 is a bottom view showing a holder and the switch body of the switch device of the sixth modified embodiment.

### DETAILED DESCRIPTION

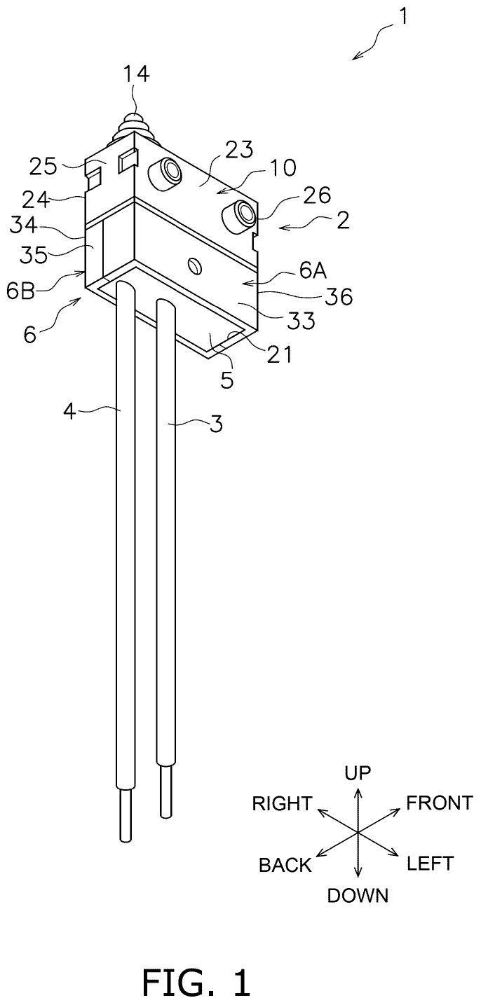

Hereinafter, an embodiment of a switch device in accordance with the claimed invention will be described with reference to the drawings. FIG. 1 is a perspective view of a switch device 1. As shown in FIG. 1, the switch device 1 includes a switch body 2, a first lead wire 3, a second lead wire 4, a sealing member 5, and a holder 6.

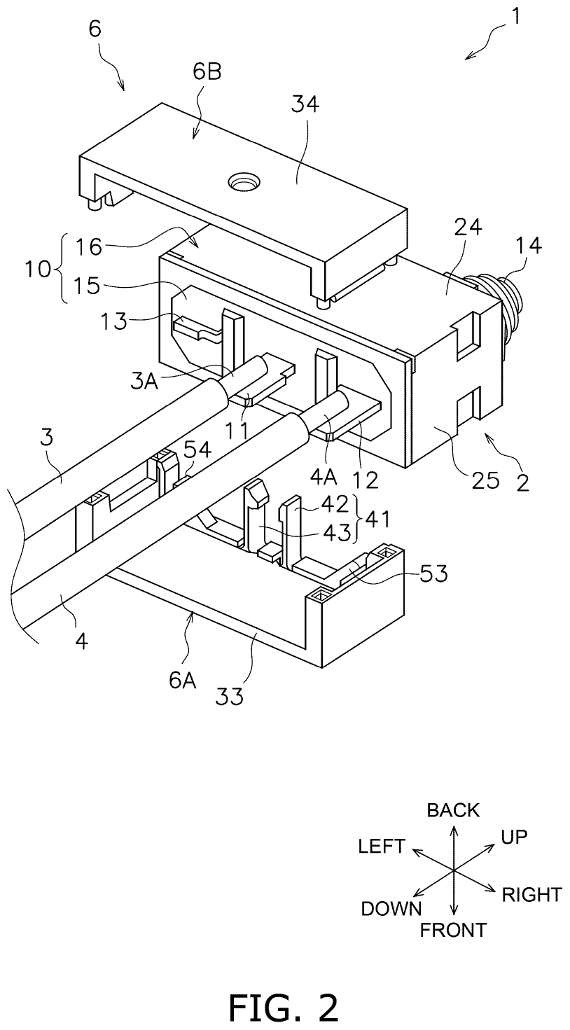

FIG. 2 is an exploded perspective view of the switch device 1. It should be noted that the sealing member 5 is omitted in FIG. 2. As shown in FIG. 2, the switch body 2 includes a switch housing 10, a first terminal 11, a second terminal 12, a third terminal 13, and a button 14. The first terminal 11, the second terminal 12, and the third terminal 13 protrude from the switch housing 10.

In this embodiment, the direction in which the first terminal 11, the second terminal 12, and the third terminal 13 protrude from the switch housing 10 is defined as the downward direction, and the opposite direction is defined as the upward direction. As shown in FIG. 2, the holder 6 includes a first holder member 6A and a second holder member 6B. The direction from the second holder member 6B toward the first holder member 6A is defined as being toward the front of the switch device 1, and the opposite direction is defined as being toward the rear of the switch device 1. Additionally, the left side facing forward is defined as the left side, and the right side facing forward is defined as the right side. It should be noted that the above-mentioned directions are defined for the convenience of explanation and do not limit the arrangement direction of the switch device 1 or the like.

As shown in FIG. 2, the switch housing 10 includes a base 15 and a case 16. The case 16 is attached to the base 15. The case 16 covers the base 15 from above. The button 14 is disposed on the top surface of the case 16. The first terminal 11, the second terminal 12, and the third terminal 13 protrude downward from the base 15. The first terminal 11, the second terminal 12, and the third terminal 13 are arranged side by side in the left-right direction. The first terminal 11 is disposed between the second terminal 12 and the third terminal 13 in the left-right direction. The second terminal 12 is disposed rightward of the first terminal 11. The third terminal 13 is disposed leftward of the first terminal 11. However, the second terminal 12 and the third terminal 13 may be arranged opposite to the above in the left-right direction.

The third terminal 13 is constantly electrically connected to the first terminal 11 in the switch housing 10. In a state that the button 14 is not pressed, the first terminal 11 and the third terminal 13 are electrically disconnected from the second terminal 12. In a state that the button 14 is pressed, the first terminal 11 and the third terminal 13 are electrically connected to the second terminal 12. However, conversely to the above, the first terminal 11 and third terminal 13 may be electrically connected to the second terminal 12 in a state that the button 14 is not pressed. The first terminal 11 and third terminal 13 may be electrically disconnected from the second terminal 12 in a state that the button 14 is pressed.

The first lead wire 3 includes a first tip portion 3A. The first tip portion 3A is electrically connected to the first terminal 11. For example, the first tip portion 3A may be connected to the first terminal 11 by soldering or welding. The first tip portion 3A and the first terminal 11 are disposed within the holder 6. The second lead wire 4 includes a second tip portion 4A. The second tip portion 4A is electrically connected to the second terminal 12. For example, the second tip portion 4A may be connected to the second terminal 12 by soldering or welding. The second tip portion 4A and the second terminal 12 are disposed within the holder 6. No lead wire is connected to the third terminal 13. However, a lead wire may be connected to the third terminal 13.

As shown in FIG. 1, the sealing member 5 is filled in the holder 6. The sealing member 5 seals the first terminal 11, the first tip portion 3A, the second terminal 12, the second tip portion 4A, and the third terminal 13. The sealing member 5 has elasticity. The sealing member 5 is waterproof. The sealing member 5 is made of a resin, such as an epoxy adhesive. The sealing member 5 is filled into the holder 6 in a heated and molten state, and then cooled and solidified, for example.

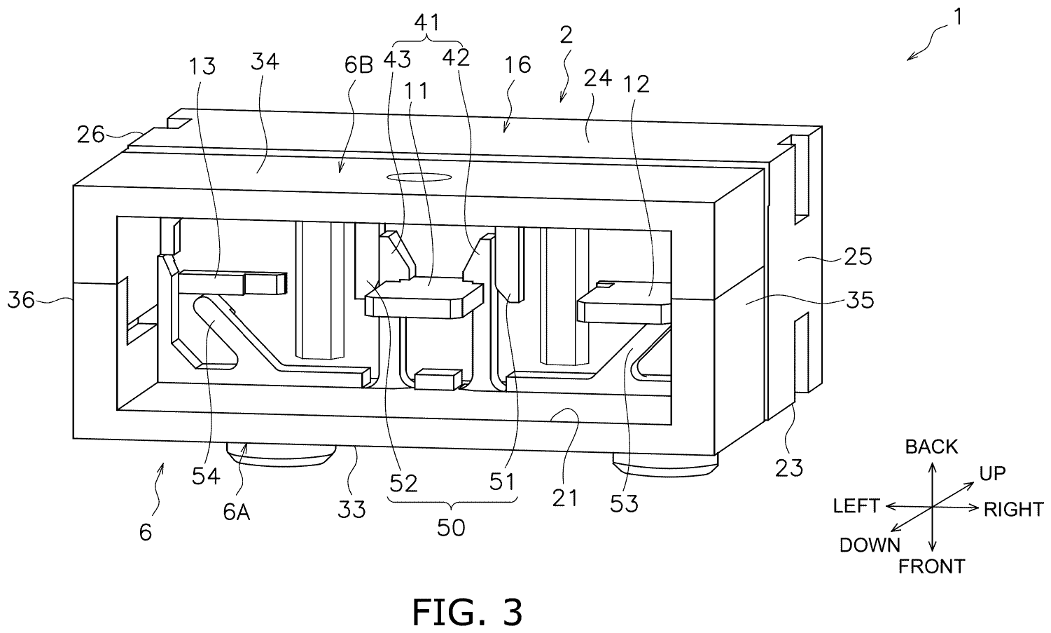

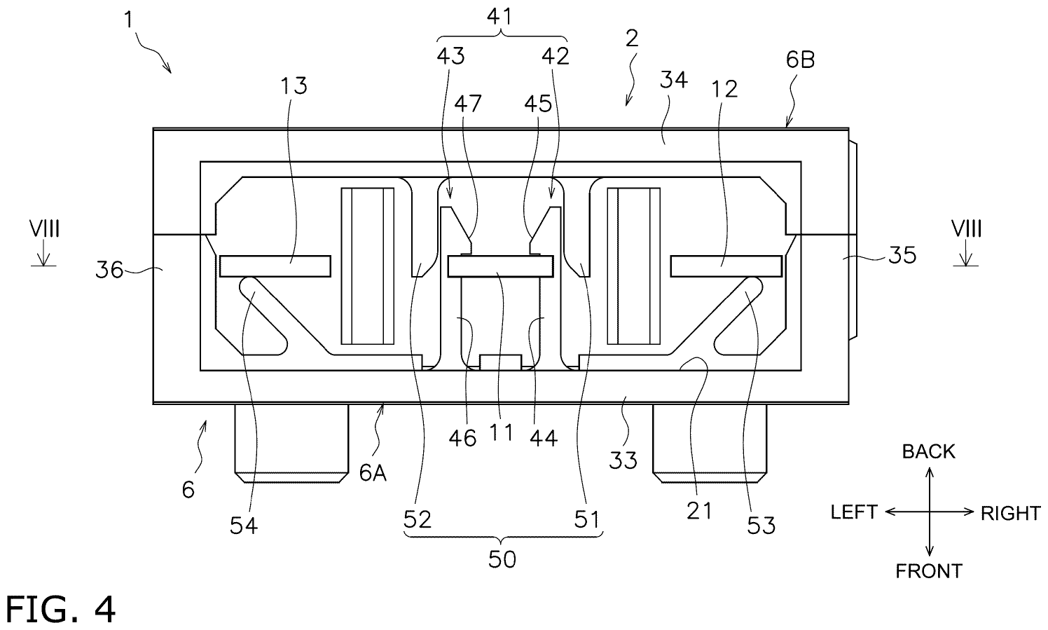

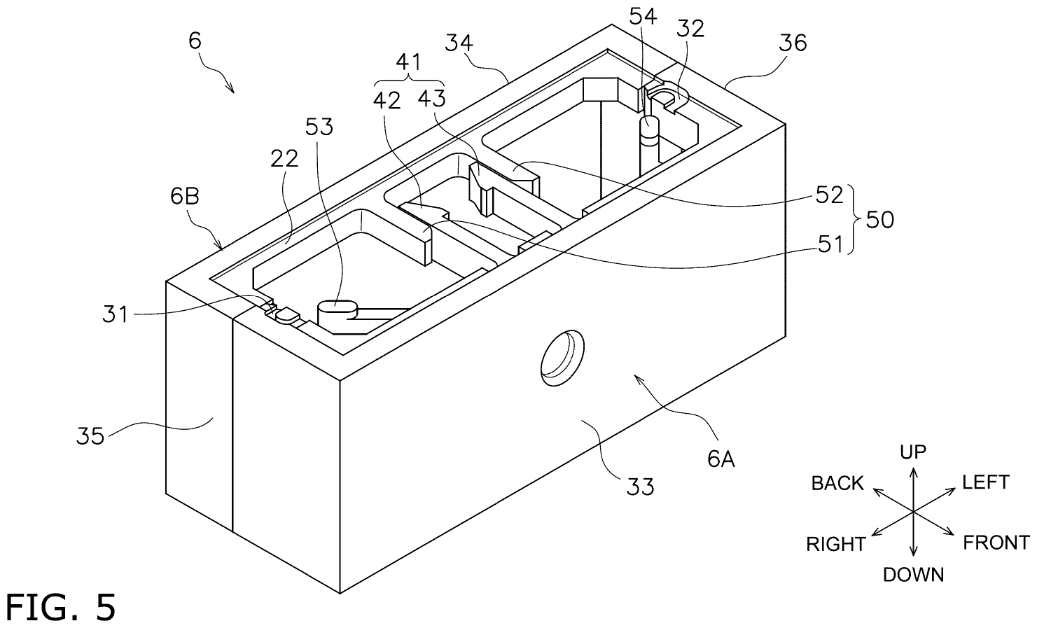

The holder 6 covers the sealing member 5. The holder 6 is made of elastic resin. FIG. 3 is a perspective view of the holder 6 and the switch body 2. FIG. 4 is a bottom view of the holder 6 and the switch body 2. FIG. 5 is a perspective view of the holder 6. As shown in FIGS. 3 to 5, the holder 6 has a box shape with openings at the top and bottom. The holder 6 includes a first opening 21 and a second opening 22. The first opening 21 is provided in the bottom surface of the holder 6. The first lead wire 3 and the second lead wire 4 extend downward through the first opening 21. The second opening 22 is provided on the top surface of the holder 6. The second opening 22 is closed by the switch body 2.

The outer shape of the holder 6 is flush with the outer shape of the switch housing 10. In particular, the switch housing 10 includes a switch front wall 23, a switch rear wall 24, a first switch side wall 25, and a second switch side wall 26. The holder 6 includes a holder front wall 33, a holder rear wall 34, a first holder side wall 35, and a second holder side wall 36. The outer surface of the holder front wall 33 is flush with the outer surface of the switch front wall 23. The outer surface of the holder rear wall 34 is flush with the outer surface of the switch rear wall 24. The outer surface of the first holder side wall 35 is flush with the outer surface of the first switch side wall 25. The outer surface of the second holder side wall 36 is flush with the outer surface of the second switch side wall 26.

As shown in FIG. 5, a first recess 31 and a second recess 32 are provided on the top surface of the holder 6. The first recess 31 and the second recess 32 communicate with the second opening 22. The first recess 31 is disposed adjacent to the first holder side wall 35. The second recess 32 is disposed adjacent to the second holder side wall 36. The first recess 31 makes it easier for the sealing member 5 to flow around the second terminal 12 when the sealing member 5 is filled. The second recess 32 makes it easier for the sealing member 5 to flow around the third terminal 13 when the sealing member 5 is filled.

As described above, the holder 6 includes the first holder member 6A and the second holder member 6B. The second holder member 6B is a separate body from the first holder member 6A. The holder 6 is divided into the first holder member 6A and the second holder member 6B from the front and rear. The second holder member 6B is disposed behind the first holder member 6A. The first holder member 6A includes the holder front wall 33 described above. The second holder member 6B includes the holder rear wall 34 described above.

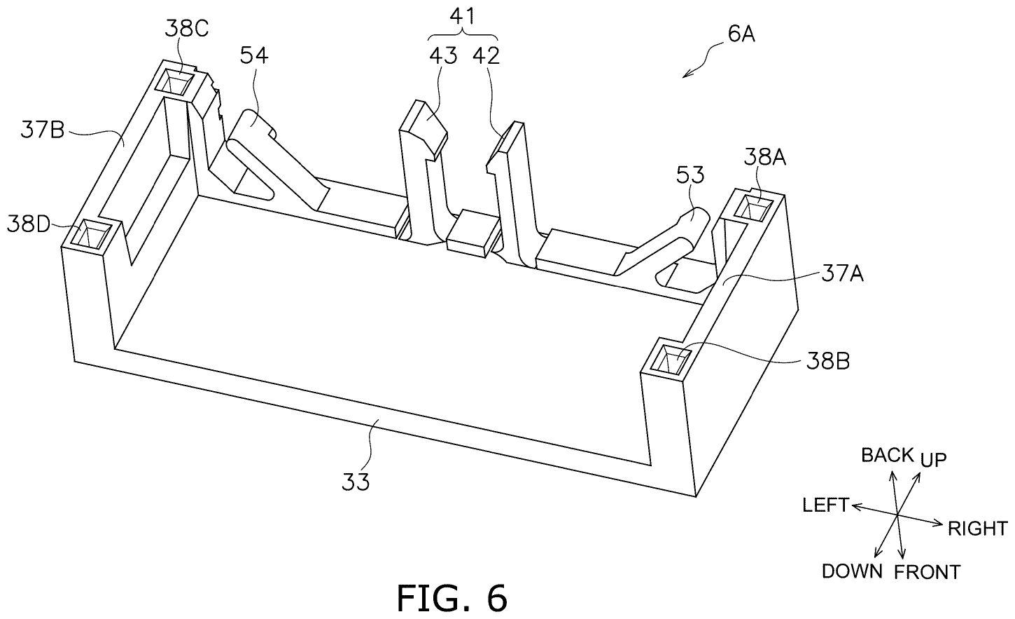

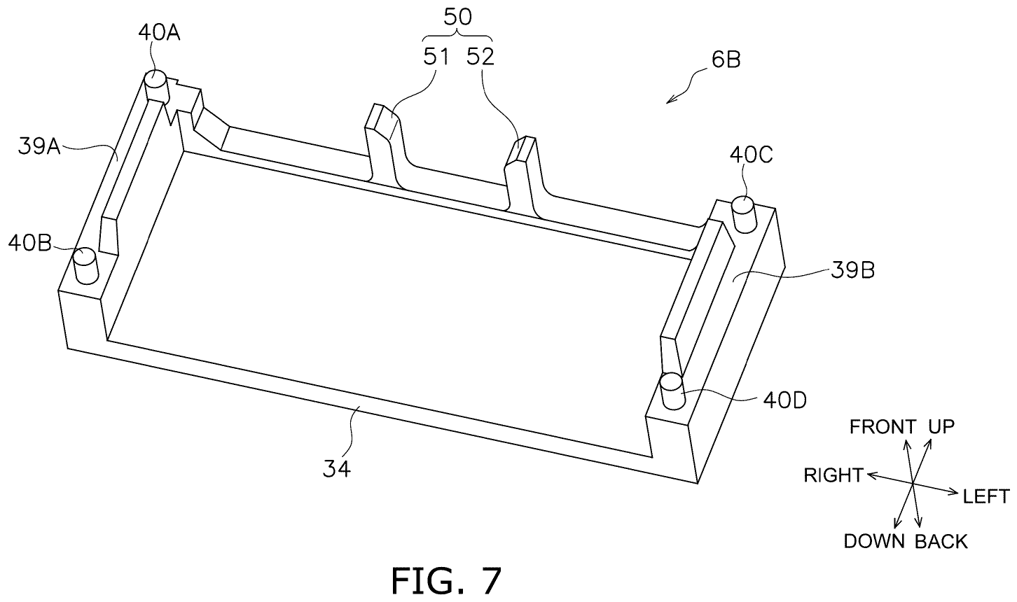

FIG. 6 is a perspective view of the first holder member 6A. FIG. 7 is a perspective view of the second holder member 6B. As shown in FIG. 6, the first holder member 6A includes a pair of first joint surfaces 37A and 37B and several mounting holes 38A-38D. The pair of first joint surfaces 37A and 37B extend in the up-down direction. The mounting holes 38A-38D include a first mounting hole 38A, a second mounting hole 38B, a third mounting hole 38C, and a fourth mounting hole 38D. The first mounting hole 38A and the second mounting hole 38B are provided on the first joint surface 37A. The third mounting hole 38C and the fourth mounting hole 38D are provided on the first joint surface 37B.

As shown in FIG. 7, the second holder member 6B includes a pair of second joint surfaces 39A and 39B and several mounting projections 40A-40D. The pair of second joint surfaces 39A and 39B extend in the up-down direction. The pair of second joint surfaces 39A and 39B are disposed to face the pair of first joint surfaces 37A and 37B, respectively. The pair of second joint surfaces 39A and 39B are jointed to the pair of first joint surfaces 37A and 37B, respectively. The projections 40A-40D include a first mounting projection 40A, a second mounting projection 40B, a third mounting projection 40C, and a fourth mounting projection 40D. The first mounting projection 40A and the second mounting projection 40B protrude from the second joint surface 39A. The third mounting projection 40C and the fourth mounting projection 40D protrude from the second joint surface 39B. The first to fourth mounting projections 40A-40D are press-fitted into the first to fourth mounting holes 38A-38D, respectively. The first holder member 6A is thereby attached to the second holder member 6B.

As shown in FIGS. 2 to 4, the holder 6 includes a connection portion 41. The connection portion 41 is disposed within the holder 6. The connection portion 41 is attached to the first terminal 11 by snap-fitting. The holder 6 is fixed to the switch body 2 by attaching the connection portion 41 to the first terminal 11.

In detail, the connection portion 41 includes a first snap-fit portion 42 and a second snap-fit portion 43. The first snap-fit portion 42 and the second snap-fit portion 43 are engaged with the first terminal 11. The first snap-fit portion 42 and the second snap-fit portion 43 engage with the first terminal 11 from the lateral sides and the rear of the first terminal 11. The first snap-fit portion 42 and the second snap-fit portion 43 extend from the inner surface of the holder 6. The first snap-fit portion 42 and the second snap-fit portion 43 are disposed apart from each other in the left-right direction. The first snap-fit portion 42 is disposed rightward of the first terminal 11. The second snap-fit portion 43 is disposed leftward of the first terminal 11.

As shown in FIG. 4, the first snap-fit portion 42 includes a first lever 44 and a first hook 45. The first lever 44 extends rearward from the inner surface of the holder front wall 33. The first lever 44 is disposed rightward of the first terminal 11. The first lever 44 engages with the first terminal 11 from the right side of the first terminal 11. The first hook 45 protrudes from the first lever 44. The first hook 45 is disposed behind the first terminal 11. The first hook 45 engages with the first terminal 11 from the rear of the first terminal 11.

The second snap-fit portion 43 includes a second lever 46 and a second hook 47. The second lever 46 extends rearward from the inner surface of the holder front wall 33. The second lever 46 is disposed leftward of the first terminal 11. The second lever 46 engages with the first terminal 11 from the left side of the first terminal 11. The second hook 47 protrudes from the second lever 46. The second hook 47 is disposed behind the first terminal 11. The second hook 47 engages with the first terminal 11 from the rear of the first terminal 11.

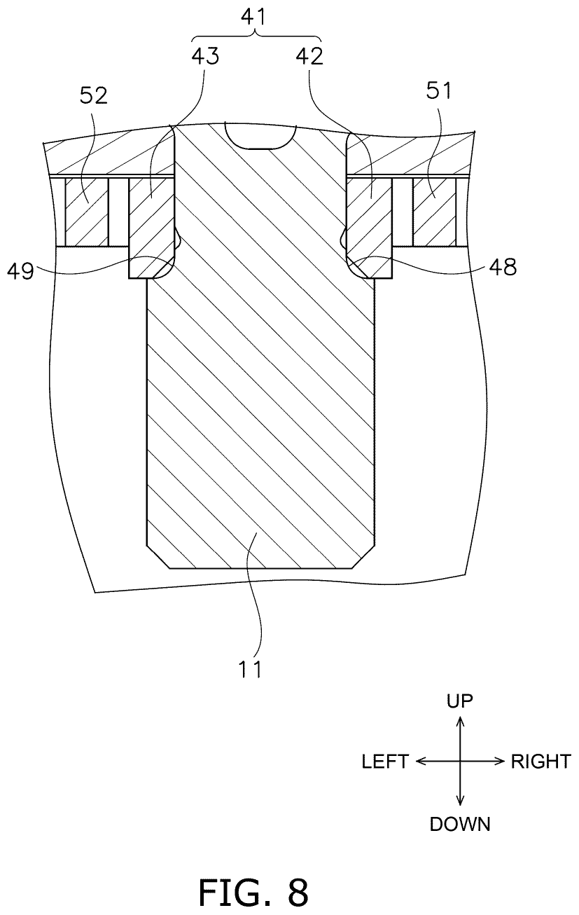

FIG. 8 is a cross-sectional view taken along line VIII-VIII in FIG. 4. As shown in FIG. 8, the first terminal 11 includes a first notch 48 and a second notch 49. The first notch 48 has a recessed shape from the left side surface of the first terminal 11. The first snap-fit portion 42 engages with the first notch 48. The first notch 48 is disposed below the first snap-fit portion 42. The first notch 48 engages with the first snap-fit portion 42 from below the first snap-fit portion 42.

The second notch 49 has a recessed shape from the right side surface of the first terminal 11. The second snap-fit portion 43 engages with the second notch 49. The second notch 49 is disposed below the second snap-fit portion 43. The second notch 49 engages with the second snap-fit portion 43 from below the second snap-fit portion 43. This prevents the holder 6 from falling downwardly from the first terminal 11.

As shown in FIG. 4, the holder 6 includes a snap-fit retainer 50. The snap-fit retainer 50 prevents the first snap-fit portion 42 and the second snap-fit portion 43 from spreading apart. The snap-fit retainer 50 includes a first extending portion 51 and a second extending portion 52. The first extending portion 51 extends forward from the inner surface of the holder rear wall 34. The first extending portion 51 is disposed rightward of the first snap-fit portion 42. The second extending portion 52 extends forward from the inner surface of the holder rear wall 34. The second extending portion 52 is disposed leftward of the second snap-fit portion 43. The first snap-fit portion 42 and the second snap-fit portion 43 are disposed between the first extending portion 51 and the second extending portion 52. The first extending portion 51 and the second extending portion 52 sandwich the first snap-fit portion 42 and the second snap-fit portion 43 therebetween, thereby preventing the first snap-fit portion 42 and the second snap-fit portion 43 from spreading apart.

The holder 6 includes a first terminal presser 53 and a second terminal presser 54. The first terminal presser 53 extends obliquely from the inner surface of the holder front wall 33 toward the second terminal 12. The first terminal presser 53 is disposed in front of the second terminal 12 and is in contact with the second terminal 12. The second terminal presser 54 extends obliquely from the inner surface of the holder front wall 33 toward the third terminal 13. The second terminal presser 54 is disposed in front of the third terminal 13 and is in contact with the third terminal 13.

As described above, the first snap-fit portion 42 and the second snap-fit portion 43 are engaged with the first terminal 11 from the lateral sides. This restricts the holder 6 from moving in the left-right direction. The first snap-fit portion 42 and the second snap-fit portion 43 are engaged with the first terminal 11 from the rear. This restricts the holder 6 from moving backward. Additionally, the first terminal presser 53 and the second terminal presser 54 contact the second terminal 12 and the third terminal 13 from the front. This restricts the holder 6 from moving forward. That is, the first and second snap-fit portions 42 and 43 and the first and second terminal pressers 53 and 54 restrict the movement of the holder 6 in the front-rear direction. Further, the first notch 48 and the second notch 49 of the first terminal 11 restrict downward movement of the holder 6. The holder 6 is thereby firmly fixed to the switch body 2.

In the switch device 1 described above, the connection portion 41 is disposed within the holder 6, and the holder 6 is fixed to the switch body 2 by attaching the connection portion 41 to the first terminal 11. The holder 6 is thereby made smaller.

Although one embodiment of the claimed invention has been described above, the claimed invention is not limited to the above embodiment, and various modifications are possible without departing from the scope of the invention.

The structure of the switch device 1 is not limited to that of the above embodiment and may be modified. The structure of the holder 6 is not limited to that in the above embodiment and may be modified. For example, in the above-described embodiment, the outer shape of the holder 6 is flush with the outer shape of the switch housing 10. However, the outer shape of the holder 6 may be smaller than the outer shape of the switch housing 10.

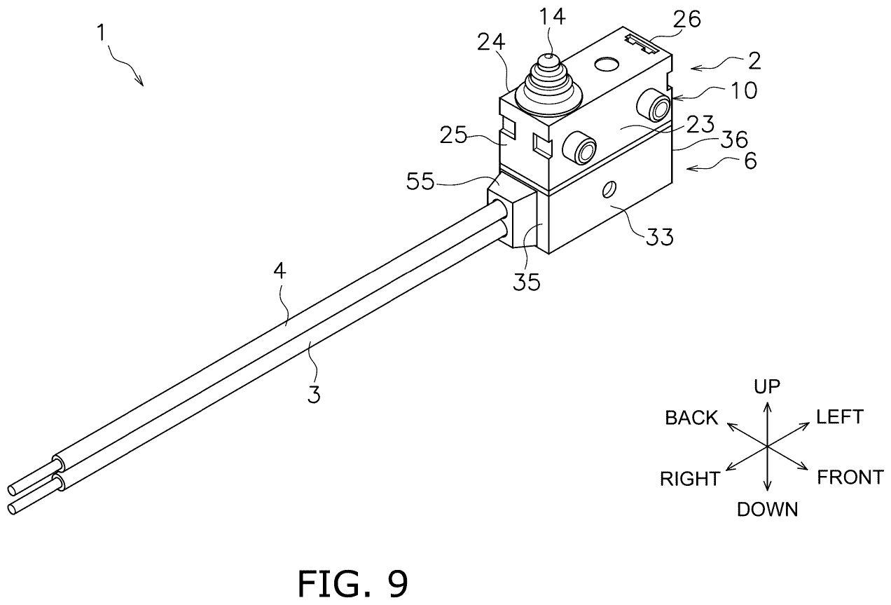

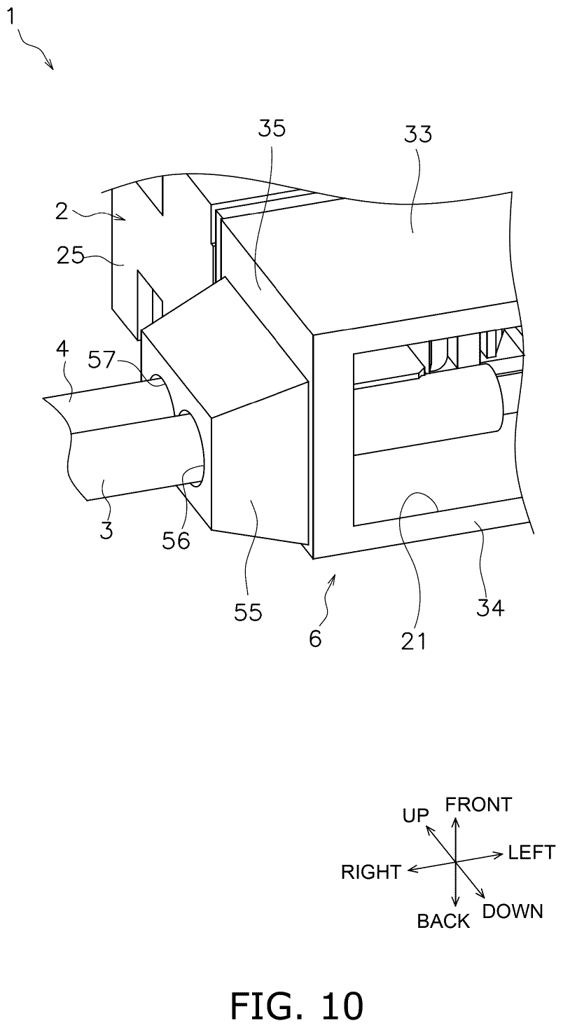

The arrangement of the lead wires 3 and 4 is not limited to that in the above embodiment and may be changed. FIGS. 9 and 10 are perspective views showing a switch device 1 of a first modified embodiment. As shown in FIGS. 9 and 10, in the switch device 1 of the first modified embodiment, the first lead wire 3 and the second lead wire 4 extend laterally from the holder 6. The holder 6 includes a lead protector 55. The lead protector 55 protrudes from the side surface of the holder 6. As shown in FIG. 10, the lead protector 55 includes a first lead hole 56 and a second lead hole 57. The first lead wire 3 extends through the first lead hole 56. The second lead wire 4 extends through the second lead hole 57.

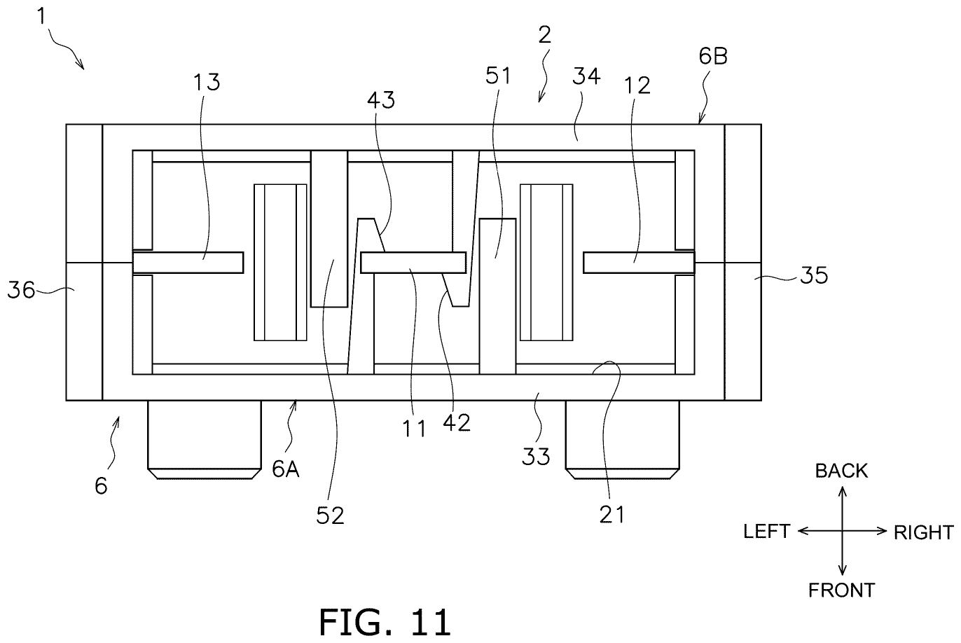

The arrangement of the first snap-fit portion 42 and the second snap-fit portion 43 is not limited to that in the above embodiment and may be changed. For example, FIG. 11 is a bottom view showing the holder 6 and the switch body 2 of the switch device 1 of the second modified embodiment. As shown in FIG. 11, the first snap-fit portion 42 and the second snap-fit portion 43 may extend from different portions of the inner surface of the holder 6. In the switch device 1 of the second modified embodiment, the first snap-fit portion 42 extends forward from the inner surface of the holder rear wall 34. The second snap-fit portion 43 extends rearward from the inner surface of the holder front wall 33.

The first extending portion 51 and the second extending portion 52 may extend from different portions of the inner surface of the holder 6. As shown in FIG. 11, in the switch device 1 of the second modified embodiment, the first extending portion 51 extends rearward from the inner surface of the holder front wall 33. The second extending portion 52 extends forward from the inner surface of the holder rear wall 34.

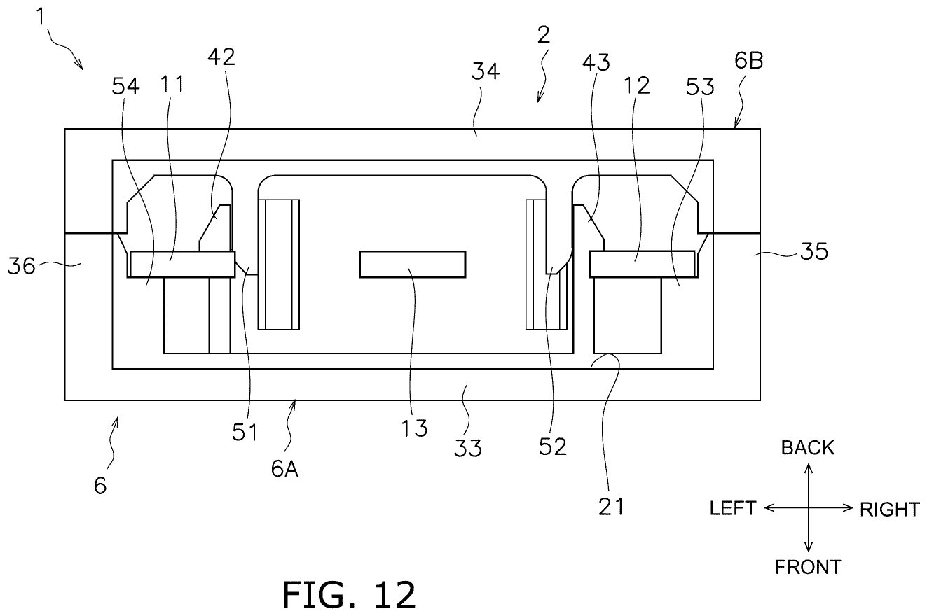

The arrangement of the first to third terminals 11-13 is not limited to that in the above embodiment and may be changed. FIG. 12 is a bottom view showing the holder 6 and the switch body 2 of the switch device 1 of the third modified embodiment. In the switch device 1 of the third modification, the third terminal 13 is disposed in the center among the first to third terminals 11-13. The first terminal 11 is disposed leftward of the third terminal 13, and the second terminal 12 is disposed rightward of the third terminal 13.

The first snap-fit portion 42 and the second snap-fit portion 43 may be engaged with different terminals. As shown in FIG. 12, in the switch device 1 of the third modified embodiment, the first snap-fit portion 42 is disposed rightward of the first terminal 11 and is engaged with the first terminal 11. The second snap-fit portion 43 is disposed leftward of the second terminal 12 and is engaged with the second terminal 12. The first extending portion 51 is disposed rightward of the first snap-fit portion 42 and prevents the first snap-fit portion 42 from expanding. The second extending portion 52 is disposed leftward of the second snap-fit portion 43 and prevents the second snap-fit portion 43 from expanding.

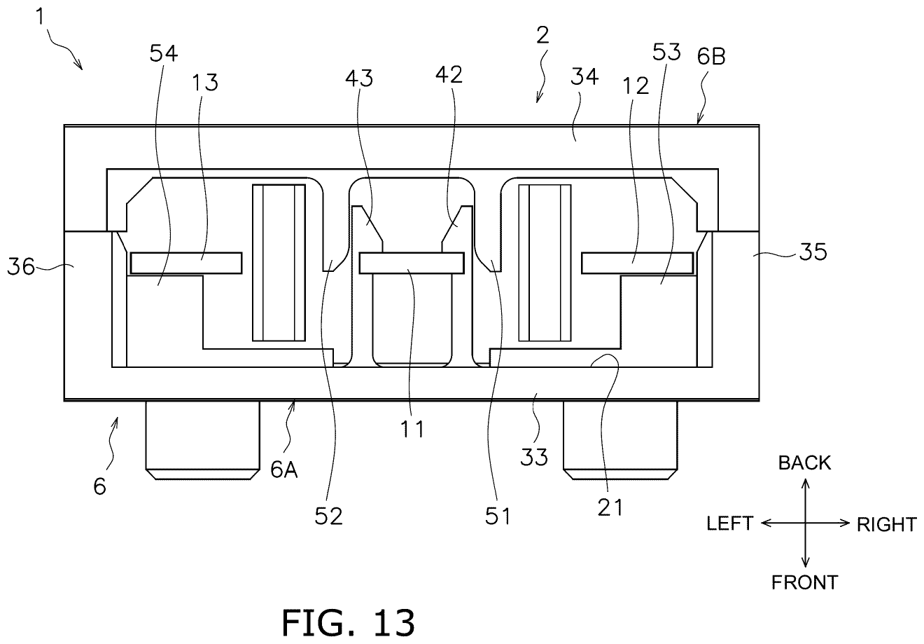

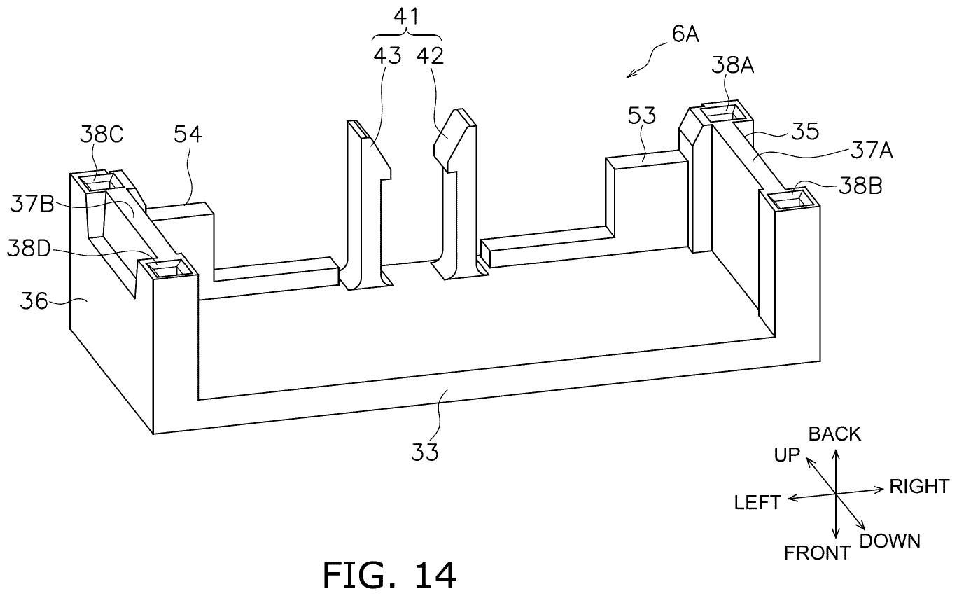

The structures of the first terminal presser 53 and the second terminal presser 54 are not limited to those in the above embodiment and may be modified. For example, FIG. 13 is a bottom view showing the holder 6 and the switch body 2 of the switch device 1 of the fourth modified embodiment. FIG. 14 is a perspective view of the first holder member 6A of the switch device 1 of the fourth modified embodiment. As shown in FIGS. 13 and 14, the first terminal presser 53 extends straight from the inner surface of the holder front wall 33 toward the second terminal 12. The first terminal presser 53 is connected to the first holder side wall 35. The second terminal presser 54 extends straight from the inner surface of the holder front wall 33 toward the third terminal 13. The second terminal presser 54 is connected to the second holder side wall 36.

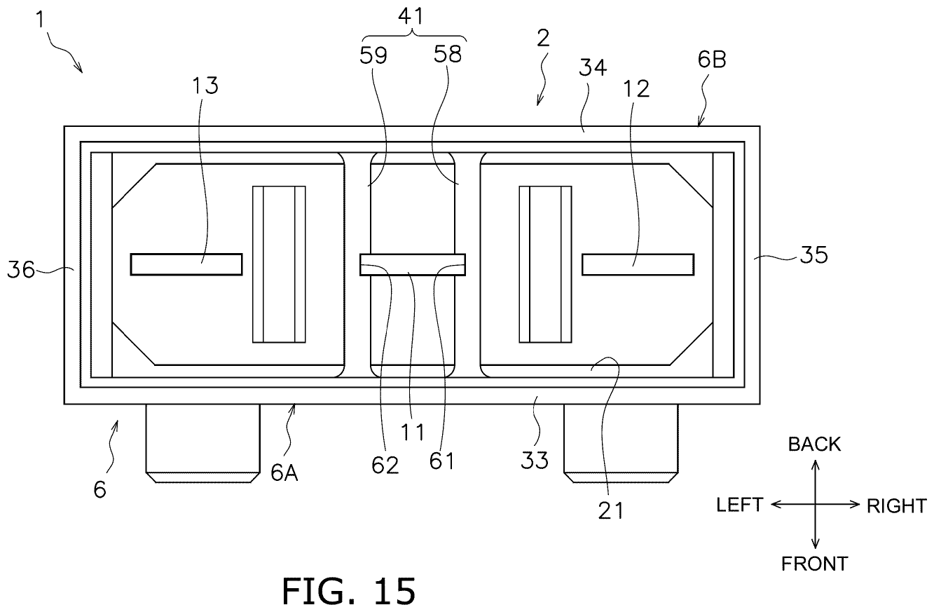

The connection portion 41 may be attached to the first terminal 11 by fixing means other than a snap-fit. FIG. 15 is a bottom view showing the holder 6 and the switch body 2 of the switch device 1 of the fifth modified embodiment. In the switch device 1 of the fifth modified embodiment, the connection portion 41 is attached to the first terminal 11 by press-fitting. The connection portion 41 includes a first press-fit portion 58 and a second press-fit portion 59. The first press-fit portion 58 is disposed rightward of the first terminal 11. The first press-fit portion 58 extends from the inner surface of the holder front wall 33 to the inner surface of the holder rear wall 34. The first press-fit portion 58 includes a first recess 61. The second press-fit portion 59 is disposed leftward of the first terminal 11. The second press-fit portion 59 extends from the inner surface of the holder front wall 33 to the inner surface of the holder rear wall 34. The second press-fit portion 59 includes a second recess 62. The first terminal 11 is press-fitted between the first recess 61 and the second recess 62.

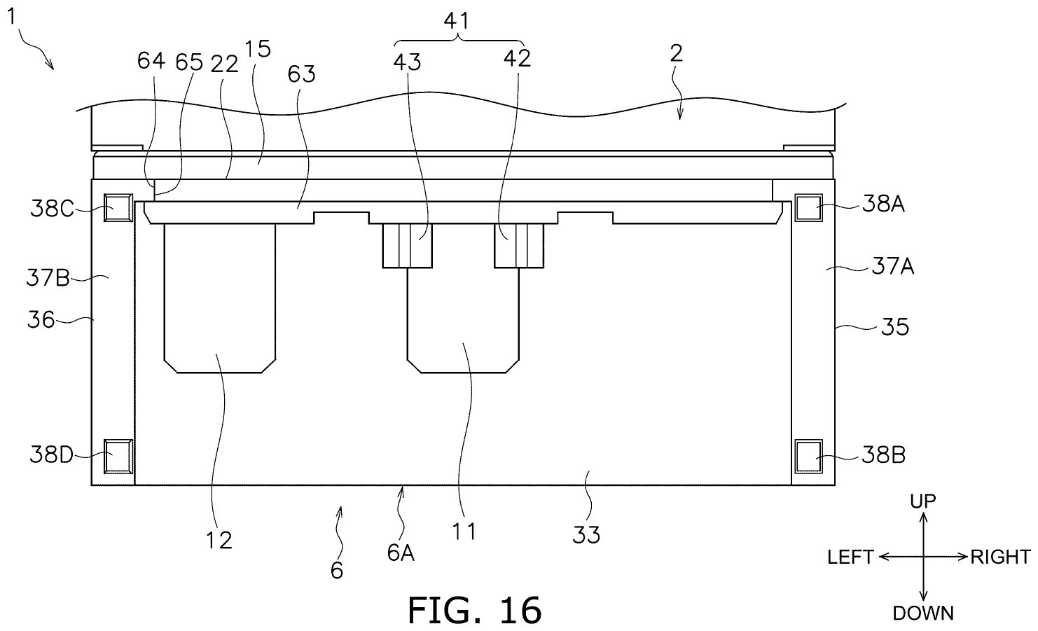

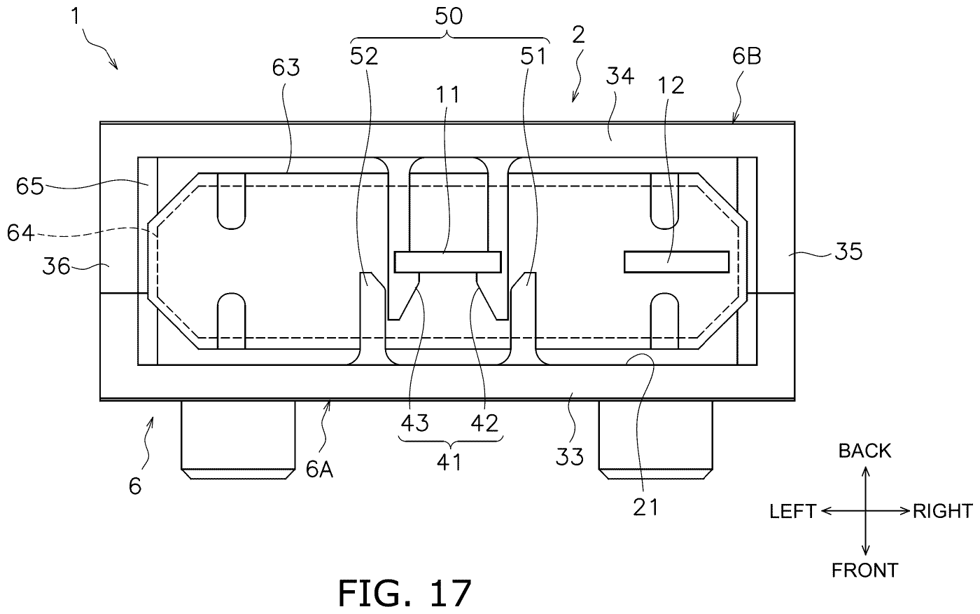

FIG. 16 is a rear view showing the first holder member 6A and the switch body 2 of the switch device 1 of the sixth modified embodiment. FIG. 17 is a bottom view showing the holder 6 and the switch body 2 of the switch device 1 of the sixth modified embodiment. In the switch device 1 of the sixth modified embodiment, the switch housing 10 includes a bottom portion 63 and a groove 64. The bottom portion 63 has an outer shape that is smaller than the outer shape of the base 15. The bottom portion 63 protrudes downward from the base 15. The bottom portion 63 is disposed within the holder 6. The groove 64 is provided on the side surface of the bottom portion 63. The holder 6 includes a protrusion 65. The protrusion 65 is provided on the edge of the second opening 22 on the top surface of the holder 6. The protrusion 65 protrudes toward the inside of the holder 6. The protrusion 65 is engaged with the groove 64. This prevents the holder 6 from falling out downward. In this case, the retention of the holder 6 by snap-fitting may be omitted.

In the above embodiment, the first snap-fit portion 42 and the second snap-fit portion 43 extend rearward from the inner surface of the holder front wall 33. However, as shown in FIG. 17, the first snap-fit portion 42 and the second snap-fit portion 43 may extend forward from the inner surface of the holder rear wall 34. In the above embodiment, the first extending portion 51 and the second extending portion 52 extend forward from the holder rear wall 34. However, as shown in FIG. 17, the first extending portion 51 and the second extending portion 52 may extend rearward from the inner surface of the holder front wall 33. As shown in FIG. 17, the third terminal 13 may be omitted.

### REFERENCE SIGNS LIST

1: Switch device, 2: Switch body, 3: First lead wire, 5: Sealing member, 6: Holder, 6A: First holder member, 6B: Second holder member, 10: Switch housing, 11: First terminal, 12: Second terminal, 38A: First mounting hole, 40A: First mounting projection, 42: First snap-fit portion, 43: Second snap-fit portion, 48: First notch, 50: Snap-fit retainer, 51: First extending portion, 52: Second extending portion, 53: First terminal presser, 55: Lead protector, 56: First lead hole, 58: First press-fit portion, 59: Second press-fit portion, 63: Bottom portion, 64: Groove, 65: Protrusion

1. A switch device, comprising:
a switch body including a switch housing and a first terminal protruding from the switch housing;
a lead wire including a tip portion electrically fixed to the first terminal;
a sealing member sealing the first terminal and the tip portion; and
a holder covering the sealing member, the holder including a connection portion disposed within the holder, the holder being fixed to the switch body by the connection portion being attached to the first terminal.

2. The switch device according to claim 1, wherein the connection portion is attached to the first terminal by snap-fitting.

3. The switch device according to claim 2, wherein the first terminal includes a notch and the connection portion is engaged with the notch to prevent the holder from coming off in a direction in which the first terminal protrudes from the switch housing.

4. The switch device according to claim 2, wherein the connection portion includes 1) a first snap-fit portion extending from an inner surface of the holder, the first snap-fit portion being disposed on a first lateral side with respect to the first terminal, the first snap-fit portion being engaged with the first terminal, and 2) a second snap-fit portion extending from the inner surface of the holder, the second snap-fit portion being disposed on a second lateral side opposite to the first lateral side with respect to the first terminal, the second snap-fit portion being engaged with the first terminal.

5. The switch device according to claim 4, wherein the holder includes a snap-fit retainer preventing the first snap-fit portion and the second snap-fit portion from spreading apart, and
the snap-fit retainer includes a first extending portion extending from the inner surface of the holder, the first extending portion being disposed on the first lateral side of the first snap-fit portion, and a second extending portion extending from the inner surface of the holder, the second extending portion being disposed on the second lateral side of the second snap-fit portion.

6. The switch device according to claim 2, wherein
switch body includes a second terminal protruding from the switch housing,
the holder includes a terminal presser extending from an inner surface of the holder, and
the terminal presser contacts the second terminal from a direction opposite to a direction in which the connection portion is engaged with the first terminal by snap-fitting.

7. The switch device according to claim 6, wherein the terminal presser extends obliquely from the inner surface of the holder toward the second terminal.

8. The switch device according to claim 2, wherein
the switch body includes a second terminal protruding from the switch housing, and
the connection portion includes a first snap-fit portion extending from an inner surface of the holder and engaging with the first terminal and a second snap-fit portion extending from the inner surface of the holder and engaging with the second terminal.

9. The switch device according to claim 1, wherein
the holder includes a first holder member including a mounting projection and a second holder member being a separate body from the first holder member, the second holder member including a mounting hole, and
the first holder member is attached to the second holder member by press-fitting the mounting projection into the mounting hole.

10. The switch structure according to claim 1, wherein the connection portion is attached to the first terminal by press-fitting.

11. The switch device according to claim 10, wherein
the connection portion includes a first press-fit portion including a first recess and extending from an inner surface of the holder and a second press-fit portion including a second recess and extending from the inner surface of the holder, and
the first terminal is press-fitted between the first recess and the second recess.

12. The switch device according to claim 1, wherein
the switch housing includes a bottom portion disposed within the holder and a groove provided on a side surface of the bottom portion,
the holder includes a protrusion protruding toward an inside of the holder, and
protrusion is engaged with the groove to prevent the holder from coming off in a direction in which the first terminal protrudes from the switch housing.

13. The switch device according to claim 1, wherein the holder includes a lead protector including a lead hole and protruding from a side surface of the holder and the lead wire extends through the lead hole.

14. The switch device according to claim 1, wherein an outer shape of the holder is the same as or smaller than an outer shape of the switch housing.

15. The switch device according to claim 1, wherein an outer shape of the holder is flush with an outer shape of the switch housing.
